(19) United States
(12) Patent Application Publication
(10) Pub. No.: US 2026/0119752 A1
(43) Pub. Date: Apr. 30, 2026

(54) VISUALIZATION OF ASSEMBLY DESIGNS GENERATED USING MACHINE LEARNING MODELS

(71) Applicant: AUTODESK, INC., San Francisco, CA (US)

(72) Inventors: Mohammadmehdi ATAEI, Toronto (CA); Hyunmin CHEONG, Toronto (CA); Justin Frank MATEJKA, Newmarket (CA); George William FITZMAURICE, Toronto (CA); Alexander TESSIER, Toronto (CA)

(21) Appl. No.: 19/255,668

(22) Filed: Jun. 30, 2025

Related U.S. Application Data
(60) Provisional application No. 63/713,025, filed on Oct. 28, 2024.

(51) Int. Cl. G06F 30/27; G06F 30/12; G06F 111/04

(52) U.S. Cl. CPC G06F 30/27; G06F 30/12; G06F 2111/04

(57) ABSTRACT

One embodiment of a computer-implemented method includes receiving the plurality of design constraints in a user interface, the plurality of design constraints defining properties of a machine assembly. The method further includes generating, using a generative machine learning model, a plurality of machine assemblies based on the plurality of design constraints, and calculating a degree to which a machine assembly from the plurality of machine assemblies conforms to the plurality of design constraints. The method also includes displaying a degree to which the machine assembly conforms to at least one design constraint from the plurality of design constraints in the user interface.

### CROSS-REFERENCE TO RELATED APPLICATIONS

This application claims priority benefit of the United States Provisional Patent Application titled, “TECHNIQUES FOR PROVIDING REAL-TIME EXPLORATION OF ARTIFICIAL INTELLIGENCE (AI)-GENERATED ASSEMBLY DESIGNS,” filed on Oct. 28, 2024, and having Ser. No. 63/713,025. The subject matter of this related application is hereby incorporated herein by reference.

### BACKGROUND

### Field of the Various Embodiments

Embodiments of the present disclosure relate generally to artificial intelligence (AI), machine learning, and computer-based simulation and, more specifically, to visualization of assembly designs generated using machine learning models.

### Description of the Related Art

Generative artificial intelligence (AI) or machine learning (ML) models can be utilized to generate machine assemblies. A machine assembly represents a design of a machine or portions of a machine, wherein the design includes one or more parts from a virtual part inventory or parts also generated using an ML model. The ML model generates a design based on one or more design constraints, such as the direction or type of an input force and the position, direction, or type of an output force. Employing a generative machine learning model to generate machine assemblies can lead to a large number of possible designs that may or may not satisfy all of the design constraints provided by a designer.

A drawback of utilizing a generative ML model to generate designs for machine assemblies is that the designer generally lacks an efficient mechanism to view, filter, or otherwise select one or more of the machine assemblies generated by generative models. In some cases, none of the generated machine assemblies satisfy all of the design constraints specified by a designer. Furthermore, a generative model can, in some cases, generate many machine assemblies in response to a designer's request without guidance as to which machine assembly is appropriate for the designer's requirements or an inventory of parts with which the designer is constrained.

As the foregoing illustrates, what is needed in the art are more effective techniques for visualizing machine assemblies generated by a generative ML model in response to one or more design constraints specified by a designer.

### SUMMARY

One embodiment sets forth a computer-implemented method for visualizing machine assemblies generated according to a plurality of design constraints. The method includes receiving the plurality of design constraints in a user interface, the plurality of design constraints defining properties of a desired machine assembly. The method further includes generating, using a generative machine learning model, a plurality of machine assemblies based on the plurality of design constraints, and calculating a degree to which a machine assembly from the plurality of machine assemblies conforms to the plurality of design constraints. The method also includes displaying a degree to which the machine assembly conforms to at least one design constraint from the plurality of design constraints in the user interface.

Further embodiments provide, among other things, one or more non-transitory computer-readable media and systems configured to implement the method set forth above.

One technical advantage of the disclosed techniques relative to the prior art is that the disclosed techniques provide mechanisms to generate, visualize, filter, and select machine assemblies generated by generative machine learning (ML) models. The disclosed techniques specify one or more design constraints for a desired machine assembly, generate one or more potential machine assemblies that satisfy the design constraints, and present the potential machine assemblies within a user interface. Additionally, the disclosed techniques determine the degree to which the generated machine assemblies comply with the design constraints. Such a determination allows the designer to assess which designs present optimal solutions. In many instances, the disclosed techniques can also automatically identify optimal designs generated by the generative ML model. The disclosed techniques allow a designer to more quickly arrive at machine assemblies that satisfy one or more design constraints and filter the machine assemblies based on various other requirements. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments.

FIG. 2 is an example data flow diagram illustrating an example of how machine generative ML model is utilized by machine design application to generate one or more machine assemblies.

FIG. 3 illustrates an example GUI and illustrates how machine design application obtains one or more design constraints via the GUI according to various embodiments.

FIG. 4 illustrates an example GUI after machine design application has invoked machine generative ML model to generate one or more machine assemblies according to various embodiments.

FIG. 5 illustrates an example GUI after machine design application has invoked machine generative ML model to generate one or more machine assemblies 148 according to various embodiments.

FIG. 6 illustrates an example GUI after machine design application has invoked machine generative ML model to generate one or more machine assemblies 148 according to various embodiments.

FIG. 7 is a flow diagram of method steps for generating a GUI corresponding to one or more machine assemblies within machine design application, according to various embodiments.

FIG. 8 depicts one architecture of a system within which embodiments of the present disclosure may be implemented.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

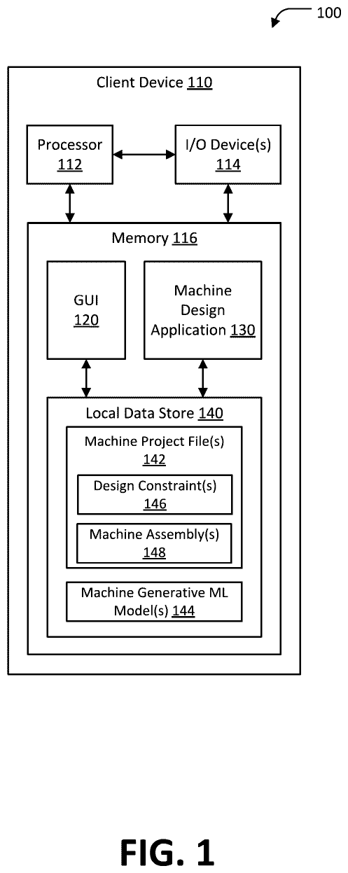

FIG. 1 is a conceptual illustration of a system 100 configured to implement one or more aspects of the various embodiments. As shown, in some embodiments, the system 100 includes, without limitation, a client device 110. The client device 110 includes, without limitation, a processor 112, one or more input/output (I/O) devices 114, and a memory 116. The memory 116 includes, without limitation, a graphical user interface (GUI) 120, a machine design application 130, and a local data store 140. The local data store 140 includes, without limitation, a machine project file 142 and a machine generative ML model 144. The machine project file 142 includes, without limitation, one or more design constraints 146 and one or more machine assemblies 148.

Any number of the components of the system 100 can be distributed across multiple geographic locations or implemented in one or more cloud computing environments, such as encapsulated shared resources, software, and data, in any combination. In some embodiments, the client device 110 and other client devices (not shown) can be implemented as one or more compute instances in a cloud computing environment, implemented as part of any other distributed computing environment, or implemented as a stand-alone entity. In various embodiments, the client device 110 can be integrated with any number and/or types of other devices, such as one or more other compute instances and/or a display device, into a client device. Some examples of client devices include, without limitation, desktop computers, laptops, smartphones, and tablets.

In general, the client device 110 is configured to implement one or more software applications. For explanatory purposes only, each software application is described as residing in the memory 116 of the client device 110 and executing on the processor 112 of the client device 110. In some embodiments, any number of instances of any number of software applications can reside in the memory 116 and any number of other memories associated with any number of other compute instances and execute on the processor 112 of the client device 110 and any number of other processors associated with any number of other compute instances in any combination. In the same or other embodiments, the functionality of any number of software applications can be distributed across any number of other software applications that reside in the memory 116 and any number of other memories associated with any number of other compute instances and execute on the processor 112 and any number of other processors associated with any number of other compute instances in any combination. Further, subsets of the functionality of multiple software applications can be consolidated into a single software application.

In particular, the client device 110 is configured to implement a machine design application 130 to generate one or more machine assemblies 148 based on one or more design constraints 146 provided by a designer or a user. Machine design application 130 utilizes machine generative ML model 144 to generate various possible designs, or the one or more machine assemblies 148. In one embodiment, machine design application 130 receives user input from a designer via a GUI 120 and from data stored in or referenced by a machine project file 142. Additionally, machine design application 130 presents the one or more machine assemblies 148 for visualization within the GUI 120, allowing a designer to view or visually explore the one or more machine assemblies 148 generated by the machine generative ML model 144, as will be further described herein. For example, based upon one or more design constraints 146 that specify the various performance, material, or cost requirements specified by the designer, the machine design application 130, utilizing machine generative ML model 144, generates one or more machine assemblies 148. The one or more machine assemblies 148 include various parts that are linked together to create an output motion that includes an output force or output result based on the provided design constraints 146.

For example, the one or more design constraints 146 can include an input motion type, such as a rotational motion, an oscillating motion, a reciprocating motion, a linear motion, or other type of motion. The one or more design constraints 146 can also specify an amount of force associated with the input motion. One or more design constraints 146 can also include an output motion type, which can include one or more of the types of motion set forth above. The one or more design constraints 146 can further include a speed ratio that specifies a ratio of the output motion relative to the input motion. One or more design constraints 146 can also include an output position, specifying a location of the output motion relative to the input motion. For example, in the case of a transmission, the output position specifies a relative offset from the location of the input force being applied to an input of the machine assembly. In other words, the output position includes a plurality of coordinates specifying a height, a width, and a depth relative to the input force position. One or more design constraints 146 can also include an output motion direction, which specifies a direction, relative to a position of the output motion, that the output motion is provided by the machine assembly. Additionally, one or more design constraints 146 can further include an output motion sign that specifies whether the output motion is positive or negative relative to the input motion. Additionally, the one or more design constraints 146 can further specify a quantity of designs that should be generated by the machine generative ML model 144 in response to a request from the machine design application 130 or the designer.

One or more design constraints 146 could also include a limited parts inventory, such as a virtual parts inventory. A virtual parts inventory can be used as a design constraint provided to the machine generative ML model 144 so that the machine generative ML model 144 uses only parts that exist in the virtual parts inventory to generate machine assemblies. The virtual parts inventory could be associated with an inventory of parts available to a manufacturer, for example. One or more design constraints 146 can also include material types or cost constraints that can be provided to the machine generative ML model 144 to achieve the other one or more design constraints 146 specified by the designer.

In various embodiments, the processor 112 can be any instruction execution system, apparatus, or device capable of executing instructions. For example, the processor 112 could comprise a central processing unit (CPU), a digital signal processing unit (DSP), a microprocessor, an application-specific integrated circuit (ASIC), a neural processing unit (NPU), a graphics processing unit (GPU), a field-programmable gate array (FPGA), a controller, a microcontroller, a state machine, or any combination thereof. In some embodiments, the processor 112 is a programmable processor that executes program instructions to manipulate input data. In some embodiments, the processor 112 can include any number of processing cores, memories, and other modules for facilitating program execution.

Input/output devices 114 include devices capable of providing input, such as a keyboard, a mouse, a touch-sensitive screen, and so forth, as well as devices capable of providing output, such as a display device. Additionally, I/O devices 114 may include devices capable of both receiving input and providing output, such as a touchscreen, a universal serial bus (USB) port, and so forth. I/O devices 114 may be configured to receive various types of input from an end-user, such as a designer, of client device 110, and to also provide various types of output to the end-user of client device 110, such as displayed digital images, digital videos, or text. In some embodiments, one or more of I/O devices 114 are configured to couple client device 110 to a network.

The memory 116 includes a memory module, or collection of memory modules. In some embodiments, the memory 116 can include a variety of computer-readable media selected for their size, relative performance, or other capabilities: volatile and/or non-volatile media, removable and/or non-removable media, etc. The memory 116 can include cache, random access memory (RAM), storage, etc. The memory 116 can include one or more discrete memory modules, such as dynamic RAM (DRAM) dual inline memory modules (DIMMs). Of course, various memory chips, bandwidths, and form factors may alternately be selected. The memory 116 stores content, such as software applications and data, for use by the processor 112. In some embodiments, a storage (not shown) supplements or replaces the memory 116. The storage can include any number and type of external memories that are accessible to the processor 112 of the client device 110. For example, and without limitation, the storage can include a Secure Digital (SD) Card, an external Flash memory, a portable compact disc read-only memory, an optical storage device, a magnetic storage device, or any suitable combination of the foregoing.

Non-volatile memory included in the memory 116 generally stores one or more application programs including the machine design application 130 and data for processing by the processor 112. In various embodiments, the memory 116 can include non-volatile memory, such as optical drives, magnetic drives, flash drives, or other storage. In some embodiments, separate data stores, such as one or more external data stores can supplement the memory 116. In various embodiments, the machine design application 130 within the memory 116 can be executed by the processor 112 to implement the overall functionality of the client device 110 to coordinate the operation of the system 100 as a whole.

In various embodiments, the memory 116 can include one or more modules for performing various functions or techniques described herein. In some embodiments, one or more of the modules and/or applications included in the memory 116 may be implemented locally on the client device 110, and/or may be implemented via a cloud-based architecture. For example, any of the modules and/or applications included in the memory 116 could be executed on a remote device, such as a smartphone, server system, or cloud computing platform, that communicates with the client device 110 via a network interface or an I/O devices interface.

The machine design application 130 resides in the memory 116 and executes on the processor 112 of the client device 110. The machine design application 130 interacts with an operator via the GUI 120. In some embodiments, the machine design application 130 and one or more separate applications (not shown) interact with the same operator via the GUI 120. In various embodiments, the machine design application 130 operates as a design studio or suite of tools that facilitate designing parts, machines, or other mechanical or electronic devices.

The GUI 120 can be any type of user interface that allows users to interact with one or more software applications via any number and/or types of GUI elements. The GUI 120 can be displayed in any technically feasible fashion on any number and/or types of stand-alone display device, any number and/or types of display screens that are integrated into any number and/or types of user devices, or any combination thereof. The machine design application 130 can perform any number and/or types of operations to directly and/or indirectly display and monitor any number and/or types of interactive GUI elements and/or any number and/or types of non-interactive GUI elements within the GUI 120. In some embodiments, each interactive GUI element enables one or more types of user interactions that automatically trigger corresponding user events. Some examples of types of interactive GUI elements include, without limitation, scroll bars, buttons, text entry boxes, drop-down lists, and sliders. In some embodiments, the machine design application 130 organizes GUI elements into one or more container GUI elements, such as panels or panes.

The local data store 140 is a part of storage in the client device 110 that stores one or more machine project file 142 in a machine project. For example, a machine project can reference mechanical design elements, parts, images, videos, and other information that is stored in or referenced by a machine project file 142.

Machine generative ML model 144 represents one or more ML models that have been trained on a relatively large amount of existing data and optionally any number of results to perform any number and/or types of generative tasks based on patterns detected in the existing data. Machine generative ML model 144 represents a generative model that receives one or more design constraints 146 as inputs and generates one or more machine assemblies as outputs. Machine generative ML model 144 can be executed by client device 110 or remotely executed and accessible to machine design application 130 via an application programming interface with which machine design application 130 submits the one or more design constraints 146 and receives one or more machine assemblies from the machine generative ML model 144 in response.

Machine generative ML model 144 is a machine learning model that has been trained on a corpus of training data. Machine generative ML model 144 can have any suitable architecture and be trained in any technically feasible manner in some embodiments. For example, in some embodiments, machine generative ML model 144 can include an artificial neural network, such as a large language model, a small language model, or the like. In some embodiments, machine generative ML model 144 can be fine-tuned on domain-specific training data after an initial training or, alternatively, may have received no additional training beyond the initial training in order to generate one or more machine assemblies 148 in a file format that can be utilized by machine design application 130. In some embodiments, machine generative ML model 144 can include a single language model, a plurality of different language models, or multiple instances of a single language model.

### Generating Machine Assemblies

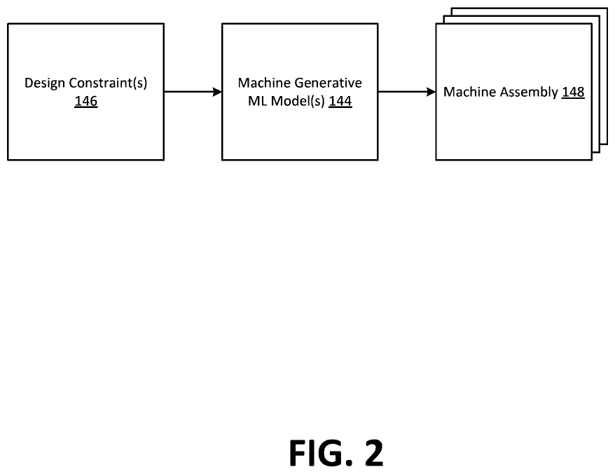

FIG. 2 is an example data flow diagram illustrating an example of how machine generative ML model 144 is utilized by machine design application 130 to generate one or more machine assemblies 148. As described above, machine design application 130 receives one or more design constraints 146 from a GUI 120 as an input. In some implementations, the one or more design constraints 146 can include a text or audio prompt from which machine design application 130 generates one or more design constraints 146. In another example, the one or more design constraints 146 are obtained from the GUI 120 of machine design application 130. For example, the GUI 120 can allow a designer to specify various properties of an input force, input motion, output ratio, output motion, and other design constraints 146 of a desired machine assembly.

The one or more design constraints 146, once obtained or extracted from the GUI 120, are provided to machine generative ML model 144. Machine generative ML model 144 generates one or more machine assemblies 148 based on the one or more design constraints 146. The one or more machine assemblies 148 can be generated in a file format compatible with machine project file 142 or machine design application 130.

The one or more machine assemblies 148 can include a three-dimensional model of a machine or portion of a machine that is generated according to the one or more design constraints 146. The one or more machine assemblies 148 can also include one or more data points that specifies conformance to the one or more design constraints 146. For example, the one or more machine assemblies 148 specifies one or more parameters quantifying an input motion, an input motion type, output motion direction, output motion position, output motion speed ratio, an output motion sign, or any other parameters quantifying conformance with the one or more design constraints 146. Because the machine generative ML model 144, in one example, is a probabilistic model that operates using a limited universe of parts and materials, and according to laws of physics and other constraints, perfect conformance to all design constraints 146 is often unachievable or impractical. Accordingly, machine generative ML model 144 might generate multiple designs that come close to achieving perfect conformance to the one or more design constraints 146, from which the designer can choose or edit the machine assembly 148.

The one or more machine assemblies 148 also specifies information which materials and parts are used in the machine assembly 148, a cost of the parts, and information about the weight of the parts used in the machine assembly 148. The machine design application 130 can then calculate the cost and weight of each respective machine assembly 148 and present cost-benefit data in a GUI 120.

### Example User Interface

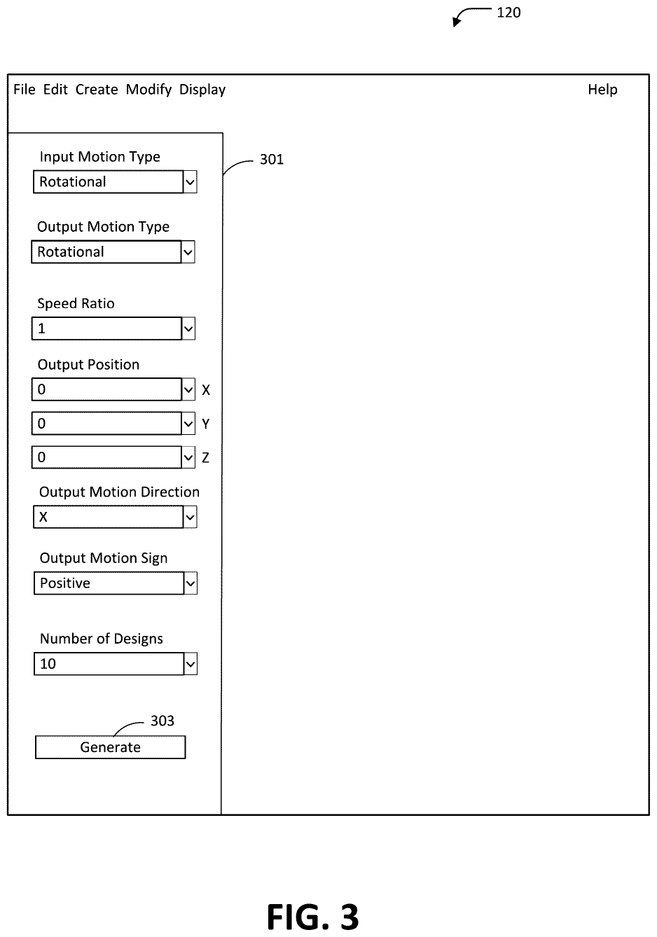

FIG. 3 illustrates an example GUI 120 and illustrates how machine design application 130 obtains one or more design constraints 146 via the GUI 120 according to various embodiments. In the example GUI 120 of FIG. 3, a requirements panel 301 is shown in which the user defines the one or more design constraints 146 from which one or more machine assemblies 148 are generated by machine generative ML model 144.

Within the GUI 120, requirements panel 301 serves as one of the primary interfaces in which a designer specifies the various requirements and constraints for a machine assembly. The requirements panel 301 allows a designer to specify material preferences, size restrictions, environmental conditions, performance criteria, and other parameters as one or more design constraints 146 that can be provided to machine generative ML model 144 according to various embodiments.

Requirements panel 301 includes one or more fields for textual inputs, dropdowns for pre-defined values, sliders for ranges, or other user interface components that allow the designer to specify the one or more design constraints 146 that will be used to generate the one or more machine assemblies 148. In some cases, machine design application 130 performs validation of the inputs to the requirements panel 301 to ensure that necessary requirements are met and logically compatible, offering suggestions if any conflicts arise between parameters. Validation allows machine design application 130 to maintain coherence across the inputs provided in requirements panel 301 and aids the user in providing meaningful data via requirements panel 301 as one or more design constraints 146 that will be provided to machine generative ML model 144.

In the GUI 120 shown in FIG. 3, once the user has specified the one or more design constraints 146 using the requirements panel 301, the user can activate the generation user interface element 303, which invokes the machine generative ML model 144 to generate the one or more machine assemblies 148 based on the one or more design constraints 146 defined in the requirements panel 301. The one or more machine assemblies 148 can be stored in association with a machine project file 142, memory 116, in local data store 140, or on a remotely located storage source in various embodiments.

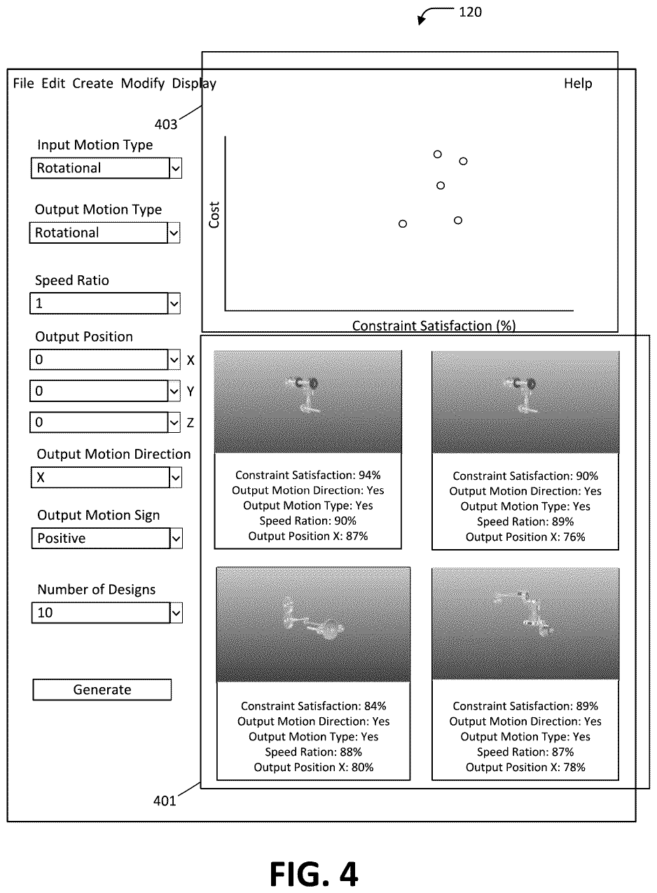

FIG. 4 illustrates an example GUI 120 after machine design application 130 has invoked machine generative ML model 144 to generate one or more machine assemblies 148 according to various embodiments. In the example GUI 120 of FIG. 4, a design explorer 401 is shown. The design explorer 401 comprises a portion of the GUI 120 in which machine design application 130 displays the one or more machine assemblies 148 generated using machine generative ML model 144. In one embodiment, machine design application 130 selects a subset of the one or more machine assemblies 148 to show in the design explorer 401, allowing the user to scroll or advance through the one or more machine assemblies 148.

In one scenario, the machine design application 130 calculates an overall constraint satisfaction score for each machine assembly from the one or more design constraints 146. The overall constraint satisfaction score represents a degree to which a respective machine assembly 148 conforms to the one or more machine assemblies 148 specified by the designer using the GUI 120. In one example, the overall constraint satisfaction score includes a percentage score calculated out of one hundred percent. In one scenario, the overall constraint satisfaction score is based on an error from a desired value of a constraint from the actual constraint from the one or more design constraints 146. In some examples, the constraints 146 can be weighted differently according to their relative importance. The weights can be user-selected or instrumented within machine design application 130. Accordingly, machine design application 130 can display the one or more machine assemblies 148 according to a ranking of overall constraint satisfaction scores in the GUI 120.

Design explorer 401 presents the machine assembly alternatives as individual cards that can be arranged in a grid format, carousel format, scrollable format, or other formats. Each card within design explorer 401 represents a different assembly design and includes a high-level image or 3D model thumbnail. Each card further includes a summary of details, such as constraint satisfaction, material, weight, estimated cost, assembly time, and other high-impact metrics. Designers can click on any card to open a more detailed view of the design. The cards can also incorporate a rating or tagging system to help the designer quickly note preferences, facilitating comparison and filtering of alternatives.

Within the design explorer 401, each depicted machine assembly 148 can also include a preview thumbnail and data about individual design constraints selected by the designer. In the example of FIG. 4, each machine assembly 148 is shown with an indication of the degree to which the machine assembly 148 conforms with individual design constraints. In the depicted example, only a subset of individual design constraints is shown, but it should be appreciated that more or fewer individual design constraints are shown along with an indication or a degree to which the machine assembly conforms to the respective design constraint.

In some scenarios, whether a machine assembly conforms with a respective design constraint is a Boolean value. In this scenario, machine design application 130 displays the design constraint along with a yes/no, true/false, or other Boolean or binary indicator. In other scenarios, the machine assembly conforms to a respective design constraint according to a percentage score. In this situation, machine design application 130 calculates a conformance score for the respective design constraint and displays the score along with the design constraint within design explorer 401.

Also shown in GUI 120 is a cost-benefit visualizer 403. Within the cost-benefit visualizer 403, machine design application 130 can plot a cost of the respective one or more machine assemblies 148 against the overall constraint satisfaction score. In some examples, the cost-benefit visualizer 403 plots a cost of a design against conformance of a subset of the one or more design constraints 146 associated with the design. In one embodiment, machine design application 130 generates a Pareto front curve on a plot of the conformance of a design to at least one design constraint against a cost associated with one or more of the machine assemblies 148.

In some embodiments, the cost-benefit visualizer 403 can also include a clustering graph that presents relationships between different design alternatives. For example, the cost-benefit visualizer 403 can include a parts similarity plot that clusters the one or more machine assemblies 148 according to the similarity or commonality of their constituent parts. In one example, similarity of parts can be computed based on the overlap of the same parts or part types. Machine assemblies 148 that share many identical parts would be placed closer together on such a clustering graph, while those machine assemblies 148 with differing components are further apart. A clustering graph allows the designer to understand the distribution of generated designs and identify clusters that might represent certain commonalities. For instance, designs that use fewer unique parts might be easier to manufacture. Interactive plots can also be used to view relationships between other key metrics, such as cost versus complexity.

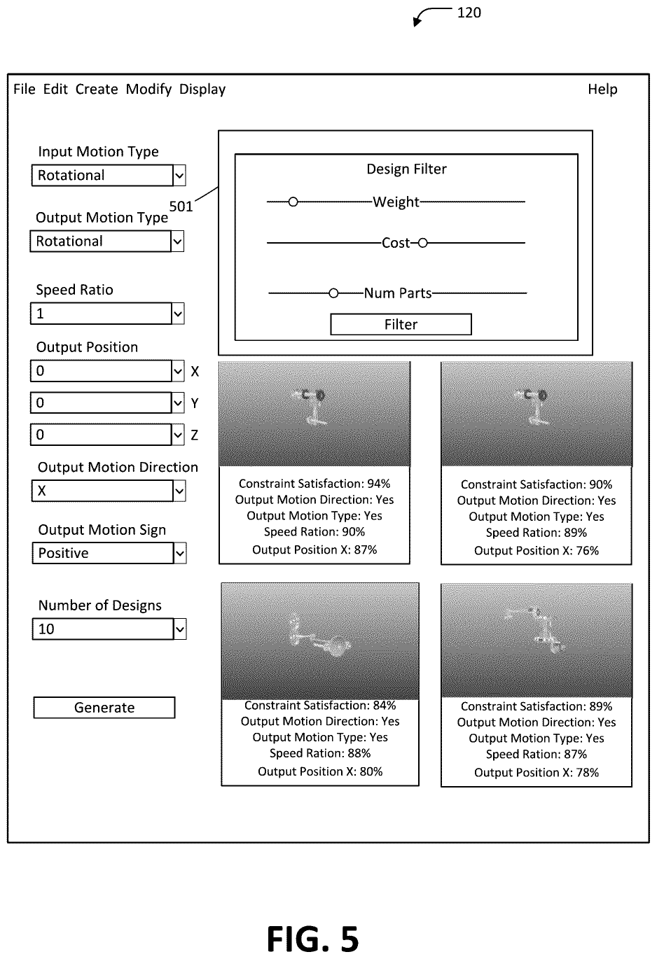

FIG. 5 illustrates an example GUI 120 after machine design application 130 has invoked machine generative ML model 144 to generate one or more machine assemblies 148 according to various embodiments. In the example GUI 120 of FIG. 5, a filtering element 501 provided by machine design application 130 is shown.

The filtering element 501 allows designers to filter the generated design alternatives for the one or more machine assemblies 148 based on various criteria, such as material, cost, parts, complexity, or manufacturability. In some implementations, filtering element 501 provides part-based filtering. In this scenario, a designer specifies a set of parts that are available in a parts inventory, and the machine design application 130, via filtering element 501, prioritizes designs incorporating those components from the parts inventory. This allows for more efficient use of an existing parts inventory, as well as design exploration because the designs shown are based on parts available in the inventory. Filters in filtering element 501 can be applied individually or in combination, narrowing down the pool of design alternatives to only those most relevant to the needs of the designer.

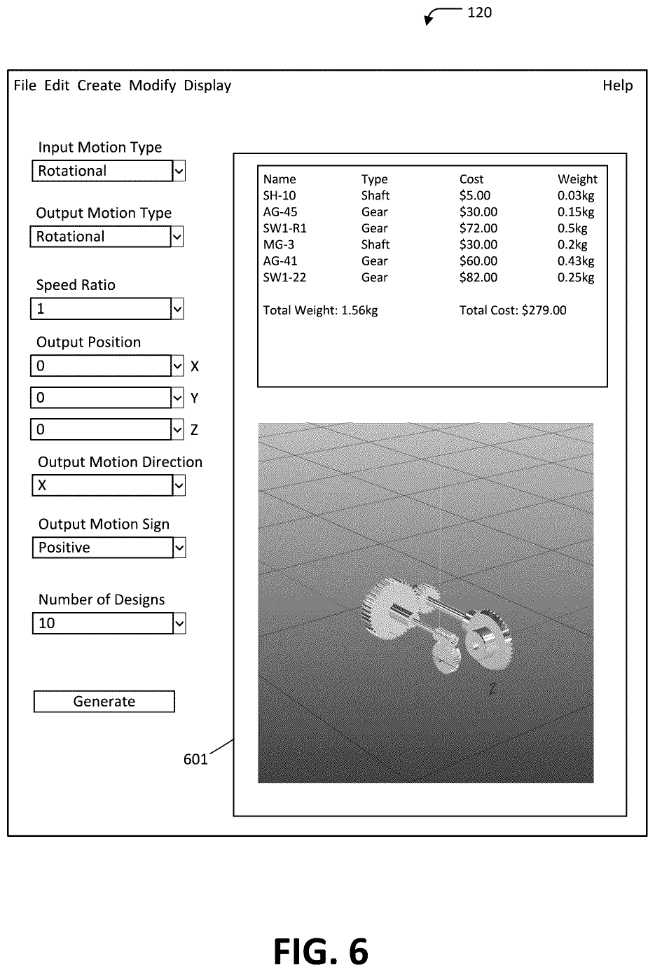

FIG. 6 illustrates an example GUI 120 after machine design application 130 has invoked machine generative ML model 144 to generate one or more machine assemblies 148 according to various embodiments. In the example GUI 120 of FIG. 6, a design explorer 601 provided by machine design application 130 is shown.

Machine design application 130 allows a user to select an individual one of the one or more machine assemblies 148 generated by machine generative ML model 144. Once a user selects a specific design, design explorer 601 presents additional available information about that machine assembly 148. In one example, design explorer 601 includes a more detailed interactive 3D model of the machine assembly 148, allowing the user to zoom, rotate, and view exploded animations of the machine assembly 148 that are generated by machine design application 130.

Additionally, a bill of materials (BOM) can be calculated by machine design application 130, which includes a listing of all components along with specifications such as weight, cost, material, part type, material type, part number, dimensions, supplier information, and other data about the respective parts. In some cases, each component can be selected for a detailed breakdown, showing individual CAD views, material properties, and manufacturability considerations. A total cost and total weight of the machine assembly 148 can also be shown within design explorer 601. Design explorer 601 can also include additional information such as estimated assembly instructions, potential failure points, or service intervals determined based on the identity of individual parts within a given machine assembly 148.

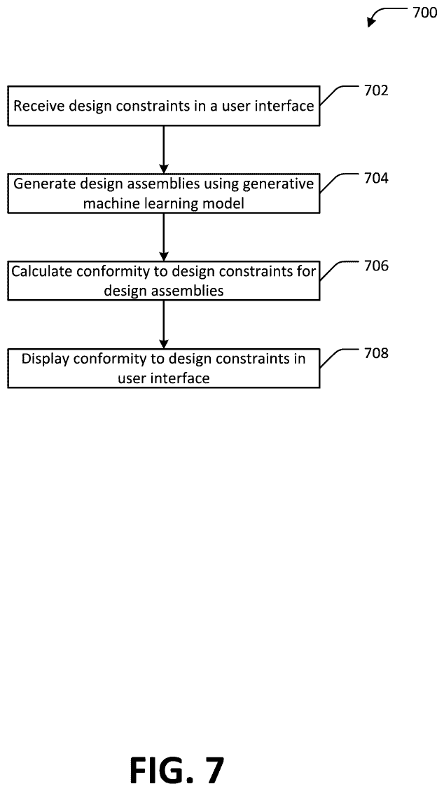

FIG. 7 is a flow diagram of method steps for generating a GUI 120 corresponding to one or more machine assemblies 148 within machine design application 130, according to various embodiments. Although the method steps are described in conjunction with the systems of FIGS. 1-6, persons skilled in the art will understand that any system configured to perform the method steps in any order falls within the scope of the present disclosure.

As shown, a method 700 begins at operation 702, where machine design application 130 receives one or more design constraints 146. The one or more design constraints 146 are obtained via a GUI 120 and can be specified by a user. The one or more design constraints 146 specify one or more aspects of a desired machine generated by machine generative ML model 144.

At operation 704, machine design application 130 generates one or more machine assemblies 148 using machine generative ML model 144. The one or more machine assemblies 148 are generated by providing the one or more design constraints 146 to the machine generative ML model 144. In some examples, one or more additional design prompts are also provided to the machine generative ML model 144 along with the one or more design constraints 146.

At operation 706, machine design application 130 calculates conformity of respective ones of the one or more machine assemblies 148 with the one or more design constraints 146 obtained at operation 702. The conformity to the one or more design constraints 146 can be an overall constraint satisfaction score of the machine assembly 148 and/or individual conformity of the machine assembly 148 with individual design constraints 146.

At operation 708, machine design application 130 displays the conformity of the machine assembly 148 to the one or more design constraints 146 in a GUI 120. As noted above, conformity can be displayed in design explorer 401, cost-benefit visualizer 403, design explorer 601, or other portions of the GUI 120. For example, the conformity of an individual machine assembly 148 to one or more design constraints 146 can be displayed along with a thumbnail image of a machine assembly 148 in design explorer 401. As another example, conformity to one or more design constraints 146 can be expressed according to an order in which the one or more machine assemblies 148 are displayed within design explorer 401. As another example, conformity to one or more design constraints 146 can be shown in a design explorer 601 when viewing an individual machine assembly 148. Additionally, in some examples, conformity to one or more design constraints 146 can also be shown within cost-benefit visualizer 403 or plotted in a Pareto front plot.

### System Implementation

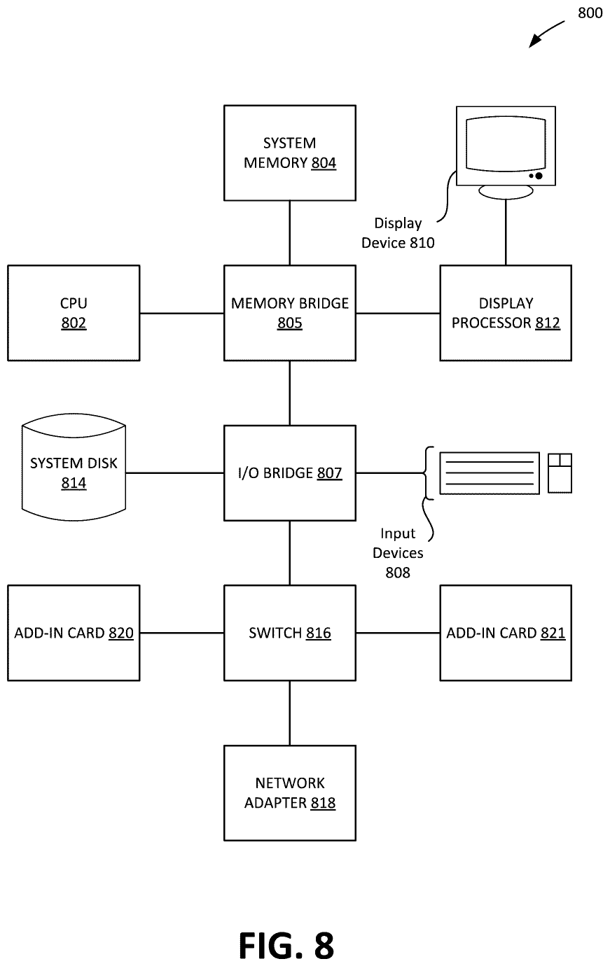

FIG. 8 is a more detailed illustration of a computing device that can implement the functionalities of the entities illustrated in FIG. 1, according to various embodiments. This figure in no way limits or is intended to limit the scope of the various embodiments. In various implementations, system 800 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 800 may be coupled together to practice one or more aspects of the various embodiments.

As shown, system 800 includes a central processing unit (CPU) 802 and a system memory 804 communicating via a bus path that may include a memory bridge 805. CPU 802 includes one or more processing cores, and, in operation, CPU 802 is the master processor of system 800, controlling and coordinating operations of other system components. System memory 804 stores software applications and data for use by CPU 802. CPU 802 runs software applications and optionally an operating system. Memory bridge 805, which may be, e.g., a Northbridge chip, is connected via a bus or other communication path (e.g., a HyperTransport link) to an I/O (input/output) bridge 807. I/O bridge 807, which may be, e.g., a Southbridge chip, receives user input from one or more user input devices 808 (e.g., keyboard, mouse, joystick, digitizer tablets, touch pads, touch screens, still or video cameras, motion sensors, and/or microphones) and forwards the input to CPU 802 via memory bridge 805.

A display processor 812 is coupled to memory bridge 805 via a bus or other communication path (e.g., a PCI Express, Accelerated Graphics Port, or HyperTransport link); in one embodiment display processor 812 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 804.

Display processor 812 periodically delivers pixels to a display device 810 (e.g., a screen or conventional CRT, plasma, OLED, SED or LCD based monitor or television). Additionally, display processor 812 may output pixels to film recorders adapted to reproduce computer generated images on photographic film. Display processor 812 can provide display device 810 with an analog or digital signal. In various embodiments, one or more of the various graphical user interfaces set forth in FIG. 3 are displayed to one or more users via display device 810, and the one or more users can input data into and receive visual output from those various graphical user interfaces.

A system disk 814 is also connected to I/O bridge 807 and may be configured to store content and applications and data for use by CPU 802 and display processor 812. System disk 814 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 816 provides connections between I/O bridge 807 and other components such as a network adapter 818 and various add-in cards 820 and 821. Network adapter 818 allows system 800 to communicate with other systems via an electronic communications network and may include wired or wireless communication over local area networks and wide area networks such as the Internet.

Other components (not shown), including USB or other port connections, film recording devices, and the like, may also be connected to I/O bridge 807. For example, an audio processor may be used to generate analog or digital audio output from instructions and/or data provided by CPU 802, system memory 804, or system disk 814. Communication paths interconnecting the various components in FIG. 6 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 812 incorporates circuitry optimized for graphics and video processing, including, for example, video output circuitry, and constitutes a graphics processing unit (GPU). In another embodiment, display processor 812 incorporates circuitry optimized for general purpose processing. In yet another embodiment, display processor 812 may be integrated with one or more other system elements, such as the memory bridge 805, CPU 802, and I/O bridge 807 to form a system on chip (SoC). In still further embodiments, display processor 812 is omitted and software executed by CPU 802 performs the functions of display processor 812.

Pixel data can be provided to display processor 812 directly from CPU 802. In some embodiments, instructions and/or data representing a scene are provided to a render farm or a set of server computers, each similar to system 800, via network adapter 818 or system disk 814. The render farm generates one or more rendered images of the scene using the provided instructions and/or data. These rendered images may be stored on computer-readable media in a digital format and optionally returned to system 800 for display. Similarly, stereo image pairs processed by display processor 812 may be output to other systems for display, stored in system disk 814, or stored on computer-readable media in a digital format.

Alternatively, CPU 802 provides display processor 812 with data and/or instructions defining the desired output images, from which display processor 812 generates the pixel data of one or more output images, including characterizing and/or adjusting the offset between stereo image pairs. The data and/or instructions defining the desired output images can be stored in system memory 804 or graphics memory within display processor 812. In an embodiment, display processor 812 includes 3D rendering capabilities for generating pixel data for output images from instructions and data defining the geometry, lighting shading, texturing, motion, and/or camera parameters for a scene. Display processor 812 can further include one or more programmable execution units capable of executing shader programs, tone mapping programs, and the like.

Further, in other embodiments, CPU 802 or display processor 812 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 802, display processor 812, or one or more other processing devices or any combination of these different processors.

CPU 802, render farm, and/or display processor 812 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 800 may be a robot or robotic device and may include CPU 802 and/or other processing units or devices and system memory 804. In such embodiments, system 800 may or may not include other elements shown in FIG. 8. System memory 804 and/or other memory units or devices in system 800 may include instructions that, when executed, cause the robot or robotic device represented by system 800 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 804 is connected to CPU 802 directly rather than through a bridge, and other devices communicate with system memory 804 via memory bridge 805 and CPU 802. In other alternative topologies display processor 812 is connected to I/O bridge 807 or directly to CPU 802, rather than to memory bridge 805. In still other embodiments, I/O bridge 807 and memory bridge 805 might be integrated into a single chip. The particular components shown herein are optional; for instance, any number of add-in cards or peripheral devices might be supported. In some embodiments, switch 816 is eliminated, and network adapter 818 and add-in cards 620, 621 connect directly to I/O bridge 807.

In sum, the disclosed techniques provide for visualization of machine assemblies generated using a machine learning model. The machine assemblies include one or more parts that receive an input and generate an output motion or force. An application receives design constraints in a user interface, where the design constraints define properties of a desired machine assembly. A generative machine learning model generates machine assemblies based on the plurality of design constraints. A degree to which a machine assembly conforms to the design constraints is calculated and displayed in a user interface. One or more of the machine assemblies can be visualized in a user interface so that a designer can visually explore, manipulate, filter or otherwise interact with the generated machine assemblies.

One technical advantage of the disclosed techniques relative to the prior art is that the disclosed techniques provide mechanisms to generate, visualize, filter, and select machine assemblies generated by generative machine learning (ML) models. The disclosed techniques specify one or more design constraints for a desired machine assembly, generate one or more potential machine assemblies that satisfy the design constraints, and present the potential machine assemblies within a user interface. Additionally, the disclosed techniques determine the degree to which the generated machine assemblies comply with the design constraints. Such a determination allows the designer to assess which designs present optimal solutions. In many instances, the disclosed techniques can also automatically identify optimal designs generated by the generative ML model. The disclosed techniques allow a designer to more quickly arrive at machine assemblies that satisfy one or more design constraints and filter the machine assemblies based on various other requirements. These technical advantages provide one or more technological improvements over prior art approaches.
1. In some embodiments, a computer-implemented method for visualizing machine assemblies generated according to a plurality of design constraints comprises receiving the plurality of design constraints via a user interface, wherein the plurality of design constraints define properties of a desired machine assembly, generating, using a generative machine learning model, a plurality of machine assemblies based on the plurality of design constraints, calculating a degree to which a machine assembly from the plurality of machine assemblies conforms to the plurality of design constraints, and displaying a degree to which the machine assembly conforms to at least one design constraint from the plurality of design constraints in the user interface.
2. The computer-implemented method of clause 1, wherein a first design constraint from the plurality of design constraints comprises a Boolean constraint.
3. The computer-implemented method of clauses 1 or 2, wherein a first design constraint from the plurality of design constraints defines an input motion type applied to the machine assembly.
4. The computer-implemented method of any of clauses 1-3, wherein a second design constraint from the plurality of design constraints comprises an output motion direction of the machine assembly in response to the first design constraint.
5. The computer-implemented method of any of clauses 1-4, wherein a first design constraint from the plurality of design constraints comprises an output motion speed relative to an input motion speed.
6. The computer-implemented method of any of clauses 1-5, wherein a first design constraint from the plurality of design constraints comprises an output position relative to an input force position.
7. The computer-implemented method of any of clauses 1-6, wherein the output position comprises a plurality of coordinates specifying a height, a width, and a depth relative to the input force position.
8. The computer-implemented method of any of clauses 1-7, wherein the degree to which the machine assembly conforms to the at least one design constraint comprises a score based on a percentage that the machine assembly satisfies the at least one design constraint.
9. The computer-implemented method of any of clauses 1-8, further comprising filtering, in the user interface, the plurality of machine assemblies based on a weight of a plurality of parts in the machine assembly.
10. The computer-implemented method of any of clauses 1-9, further comprising filtering, in the user interface, the plurality of machine assemblies based on a cost of a plurality of parts in the machine assembly.
11. The computer-implemented method of any of clauses 1-10, further comprising filtering, in the user interface, the plurality of machine assemblies based on a quantity of parts in the machine assembly.
12. The computer-implemented method of any of clauses 1-11, further comprising displaying, in the user interface, a pareto front curve on a plot of the at least one design constraint and a cost associated with the plurality of machine assemblies.
13. In some embodiments, one or more non-transitory computer-readable storage media include instructions that, when executed by at least one processor, cause the at least one processor to perform steps for visualizing machine assemblies generated according to a plurality of design constraints, the steps comprising receiving the plurality of design constraints in a user interface, the plurality of design constraints defining properties of a desired machine assembly, generating, using a generative machine learning model, a plurality of machine assemblies based on the plurality of design constraints, calculating a degree to which a machine assembly from the plurality of machine assemblies conforms to the plurality of design constraints, and displaying a degree to which the machine assembly conforms to at least one design constraint from the plurality of design constraints in the user interface.
14. The one or more non-transitory computer-readable storage media of clause 13, wherein the instructions, when executed by the at least one processor, further cause the at least one processor to perform steps comprising filtering, via the user interface, the plurality of machine assemblies according to a material type of components of respective machine assemblies from the plurality of machine assemblies.
15. The one or more non-transitory computer-readable storage media of clauses 13 or 14, wherein the instructions, when executed by the at least one processor, further cause the at least one processor to perform steps comprising displaying a total weight of a respective machine assembly in the user interface based on a weight of respective components of the respective machine assembly.
16. The one or more non-transitory computer-readable storage media of any of clauses 13-15, further comprising filtering, in the user interface, the plurality of machine assemblies based on a weight of a plurality of parts in the machine assembly.
17. The one or more non-transitory computer-readable storage media of any of clauses 13-16, wherein a degree to which the machine assembly conforms to the at least one design constraint comprises a score based on a percentage that the machine assembly satisfies the at least one design constraint.
18. The one or more non-transitory computer-readable storage media of any of clauses 13-17, further comprising displaying, in the user interface, a pareto front curve on a plot of the at least one design constraint and a cost associated with the plurality of machine assemblies.
19. The one or more non-transitory computer-readable storage media of any of clauses 13-18, further comprising filtering, in the user interface, the plurality of machine assemblies based on a quantity of parts in the machine assembly.
20. In some embodiments, a system comprises one or more memories storing instructions, and one or more processors that are coupled to the one or more memories and, when executing the instructions, are configured to perform steps for visualizing machine assemblies generated according to a plurality of design constraints, the steps comprising receiving the plurality of design constraints in a user interface, the plurality of design constraints defining properties of a desired machine assembly, generating, using a generative machine learning model, a plurality of machine assemblies based on the plurality of design constraints, calculating a degree to which a machine assembly from the plurality of machine assemblies conforms to the plurality of design constraints, and displaying a degree to which the machine assembly conforms to at least one design constraint from the plurality of design constraints in the user interface.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for visualizing machine assemblies generated according to a plurality of design constraints, the method comprising:
receiving the plurality of design constraints via a user interface, wherein the plurality of design constraints define properties of a desired machine assembly;
generating, using a generative machine learning model, a plurality of machine assemblies based on the plurality of design constraints;
calculating a degree to which a machine assembly from the plurality of machine assemblies conforms to the plurality of design constraints; and
displaying a degree to which the machine assembly conforms to at least one design constraint from the plurality of design constraints in the user interface.

2. The computer-implemented method of claim 1, wherein a first design constraint from the plurality of design constraints comprises a Boolean constraint.

3. The computer-implemented method of claim 1, wherein a first design constraint from the plurality of design constraints defines an input motion type applied to the machine assembly.

4. The computer-implemented method of claim 2, wherein a second design constraint from the plurality of design constraints comprises an output motion direction of the machine assembly in response to the first design constraint.

5. The computer-implemented method of claim 1, wherein a first design constraint from the plurality of design constraints comprises an output motion speed relative to an input motion speed.

6. The computer-implemented method of claim 1, wherein a first design constraint from the plurality of design constraints comprises an output position relative to an input force position.

7. The computer-implemented method of claim 6, wherein the output position comprises a plurality of coordinates specifying a height, a width, and a depth relative to the input force position.

8. The computer-implemented method of claim 1, wherein the degree to which the machine assembly conforms to the at least one design constraint comprises a score based on a percentage that the machine assembly satisfies the at least one design constraint.

9. The computer-implemented method of claim 1, further comprising filtering, in the user interface, the plurality of machine assemblies based on a weight of a plurality of parts in the machine assembly.

10. The computer-implemented method of claim 1, further comprising filtering, in the user interface, the plurality of machine assemblies based on a cost of a plurality of parts in the machine assembly.

11. The computer-implemented method of claim 1, further comprising filtering, in the user interface, the plurality of machine assemblies based on a quantity of parts in the machine assembly.

12. The computer-implemented method of claim 1, further comprising displaying, in the user interface, a pareto front curve on a plot of the at least one design constraint and a cost associated with the plurality of machine assemblies.

13. One or more non-transitory computer-readable storage media including instructions that, when executed by at least one processor, cause the at least one processor to perform steps for visualizing machine assemblies generated according to a plurality of design constraints, the steps comprising:
receiving the plurality of design constraints in a user interface, the plurality of design constraints defining properties of a desired machine assembly;
generating, using a generative machine learning model, a plurality of machine assemblies based on the plurality of design constraints;
calculating a degree to which a machine assembly from the plurality of machine assemblies conforms to the plurality of design constraints; and
displaying a degree to which the machine assembly conforms to at least one design constraint from the plurality of design constraints in the user interface.

14. The one or more non-transitory computer-readable storage media of claim 13, wherein the instructions, when executed by the at least one processor, further cause the at least one processor to perform steps comprising:
filtering, via the user interface, the plurality of machine assemblies according to a material type of components of respective machine assemblies from the plurality of machine assemblies.

15. The one or more non-transitory computer-readable storage media of claim 13, wherein the instructions, when executed by the at least one processor, further cause the at least one processor to perform steps comprising displaying a total weight of a respective machine assembly in the user interface based on a weight of respective components of the respective machine assembly.

16. The one or more non-transitory computer-readable storage media of claim 13, further comprising filtering, in the user interface, the plurality of machine assemblies based on a weight of a plurality of parts in the machine assembly.

17. The one or more non-transitory computer-readable storage media of claim 13, wherein a degree to which the machine assembly conforms to the at least one design constraint comprises a score based on a percentage that the machine assembly satisfies the at least one design constraint.

18. The one or more non-transitory computer-readable storage media of claim 13, further comprising displaying, in the user interface, a pareto front curve on a plot of the at least one design constraint and a cost associated with the plurality of machine assemblies.

19. The one or more non-transitory computer-readable storage media of claim 13, further comprising filtering, in the user interface, the plurality of machine assemblies based on a quantity of parts in the machine assembly.

20. A system, comprising:
one or more memories storing instructions; and
one or more processors that are coupled to the one or more memories and, when executing the instructions, are configured to perform steps for visualizing machine assemblies generated according to a plurality of design constraints, the steps comprising:
receiving the plurality of design constraints in a user interface, the plurality of design constraints defining properties of a desired machine assembly;
generating, using a generative machine learning model, a plurality of machine assemblies based on the plurality of design constraints;
calculating a degree to which a machine assembly from the plurality of machine assemblies conforms to the plurality of design constraints; and
displaying a degree to which the machine assembly conforms to at least one design constraint from the plurality of design constraints in the user interface.
